(19) United States
(12) Patent Application Publication
(10) Pub. No.: US 2025/0284508 A1
(43) Pub. Date: Sep. 11, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Junichiro Mori, Kanagawa (JP)

(73) Assignee: FUJIFILM Business Innovation Corp., Tokyo (JP)

(21) Appl. No.: 18/772,776

(22) Filed: Jul. 15, 2024

(30) Foreign Application Priority Data
Mar. 27, 2024 (JP) 2024-052468

(51) Int. Cl. G06F 9/451

(52) U.S. Cl. CPC G06F 9/453

(57) ABSTRACT

An information processing system includes a processor configured to, when a solution request for a failure of a device in which the failure has occurred is received from a user who uses the device, request the user to provide information related to solution for the failure, and display, to the user, an indication related to an amount of work required from the user when a transition is made to another way of solution for the failure.

### CROSS-REFERENCE TO RELATED APPLICATIONS

This application is based on and claims priority under 35 USC 119 from Japanese Patent Application No. 2024-052468 filed Mar. 27, 2024.

### BACKGROUND

### (i) Technical Field

The present disclosure relates to an information processing system and a non-transitory computer readable medium.

### (ii) Related Art

For example, in International Publication No. 2020/240838, an instruction to start a conversation with a chatbot and attribute information of a user acquired by an information processing terminal used by the user are received from the information processing terminal. There has been disclosed an information processing apparatus that starts a conversation with a chatbot in an information processing terminal using script information determined based on attribute information of a user by referring to a storage unit that stores script information corresponding to each of a plurality of user attributes.

### SUMMARY

Aspects of non-limiting embodiments of the present disclosure relate to an information processing system that collects information provided by a user who uses a device in which a failure has occurred, and prompts the user to continue providing information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to, when a solution request for a failure of a device in which the failure has occurred is received from a user who uses the device, request the user to provide information related to solution for the failure, and display, to the user, an indication related to an amount of work required from the user when a transition is made to another way of solution for the failure.

### BRIEF DESCRIPTION OF THE DRAWINGS

Exemplary embodiments of the present disclosure will be described in detail based on the following figures, wherein:

FIG. 1 is a diagram illustrating a response system according to an exemplary embodiment of the present disclosure;

FIG. 2 is a diagram illustrating a system configuration of a chatbot according to the exemplary embodiment of the present disclosure;

FIG. 3 is a diagram illustrating contents displayed on an input screen operated by a user according to the exemplary embodiment of the present disclosure;

FIG. 4 is a diagram illustrating contents displayed on a display unit according to the exemplary embodiment of the present disclosure following FIG. 3, and is a diagram illustrating the contents in a state where information is provided from the user and a new question is displayed;

FIG. 5 is a diagram illustrating contents displayed on the display unit according to the exemplary embodiment of the present disclosure following FIG. 4, and is a diagram illustrating the contents in a state where the user has continued providing information;

FIG. 6 is a diagram illustrating a first confirmation indication that is an example of an indication related to work details according to the exemplary embodiment of the present disclosure and that is displayed on the input screen operated by the user in a case where the user attempts to leave in a state with a low information sufficiency level;

FIG. 7 is a diagram illustrating a second confirmation indication that is an example of an indication related to work details according to the exemplary embodiment of the present disclosure and that is displayed on the input screen operated by the user in a case where the user attempts to leave in a state with a medium information sufficiency level;

FIG. 8 is a diagram illustrating a third confirmation indication that is an example of an indication related to work details according to the exemplary embodiment of the present disclosure and that is displayed on the input screen operated by the user in a case where the user attempts to leave in a state with a high information sufficiency level; and

FIG. 9 is a flowchart illustrating an operation procedure of the response system according to the exemplary embodiment of the present disclosure.

### DETAILED DESCRIPTION

Hereinafter, an example of an exemplary embodiment of the present disclosure will be described with reference to the drawings. Note that in the drawings, the same or equivalent components and parts are denoted by the same reference signs. In addition, dimensional ratios in the drawings are exaggerated for convenience of description and may be different from actual ratios.

### Exemplary Embodiment

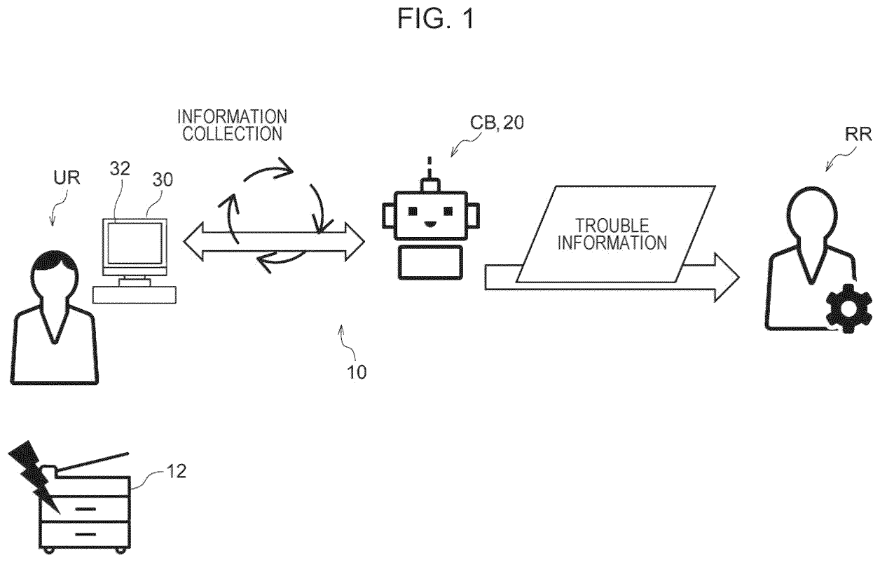

FIG. 1 is a diagram illustrating a usage example of a response system 10, which is an example of an information processing system according to the present exemplary embodiment. As illustrated in FIG. 1, the response system 10 includes an input device 30 for a user UR and a computer 20 to which the input device 30 is connected via a network, and is used when the user UR who is a person using a printer 12 makes an inquiry about the printer 12.

### (Computer 20)

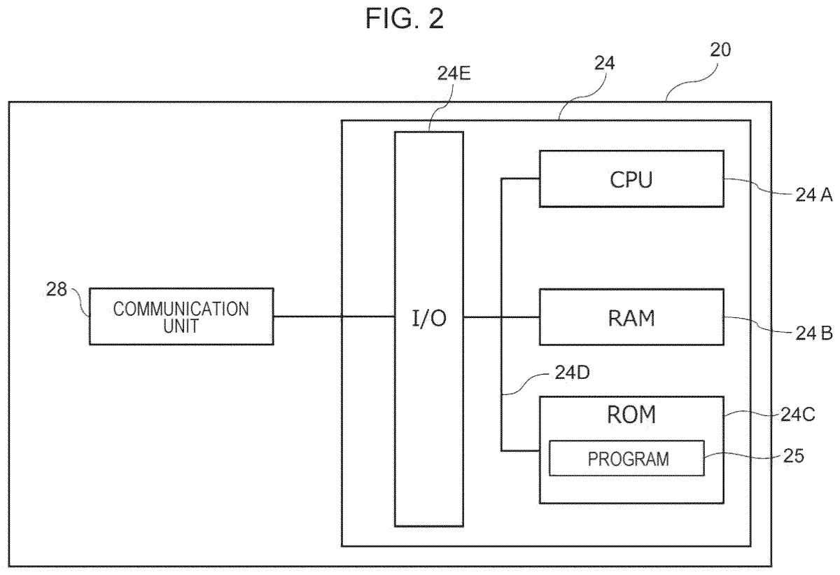

As illustrated in FIG. 2, the computer 20 includes a communication unit 28 and a control unit 24. Furthermore, as illustrated in FIG. 2, the control unit 24 includes a CPU 24A, a RAM 24B, a ROM 24C, and an input/output interface (I/O) 24E. These components are connected to each other via a control bus 24D.

The communication unit 28 is a component for communicating with other devices via a network (not illustrated). Specifically, the communication unit 28 communicates with other devices by using wired or wireless communications, as well as communications using the Internet, an intranet, and a public line such as a telephone line.

The CPU 24A is a central processing unit, which is an example of a “processor” that executes various programs and controls each unit. The RAM 24B, as a work area, temporarily stores therein a program 25 or data. The ROM 24C stores various types of data including a “program” according to the present disclosure.

In the control unit 24, the CPU 24A reads various programs including the processing program 25 from the ROM 24C, and executes the program 25 using the RAM 24B as a work area. By executing the processing program 25, the CPU 24A realizes various functions for controlling each unit of the computer 20.

The computer 20 according to the present exemplary embodiment executes the response system 10 when the CPU 24A executes the program 25. The response system 10 is, for example, a so-called chatbot that displays a predetermined question to get an answer from the user UR. Further, the response system 10 prompts the user UR to provide information on a failure of the printer 12 by displaying an input screen 32 for inputting a question 36 on the display screen of the input device 30 for the user UR.

More specifically, as illustrated in FIG. 1, when a failure has occurred in the printer 12 used by the user UR, the user UR uses the response system 10, which is made available on a website of the distributor, by using the input device 30. Then, the response system 10 provides a repair person RR with the contents of the solution to the failure obtained based on the information provided from the user UR. Thereafter, the repair person RR visits the user UR and addresses the cause of the failure of the printer 12 based on the contents of the solution to the failure provided from the user UR.

In other words, the use of the response system 10 by the user UR is an example of issuing a solution request for a device failure according to the present exemplary embodiment. Displaying, by the CPU 24A, the input screen 32 for inputting an answer to the question 36 on the display screen of the input device 30 used by the user UR is an example of receiving a solution request according to the present exemplary embodiment.

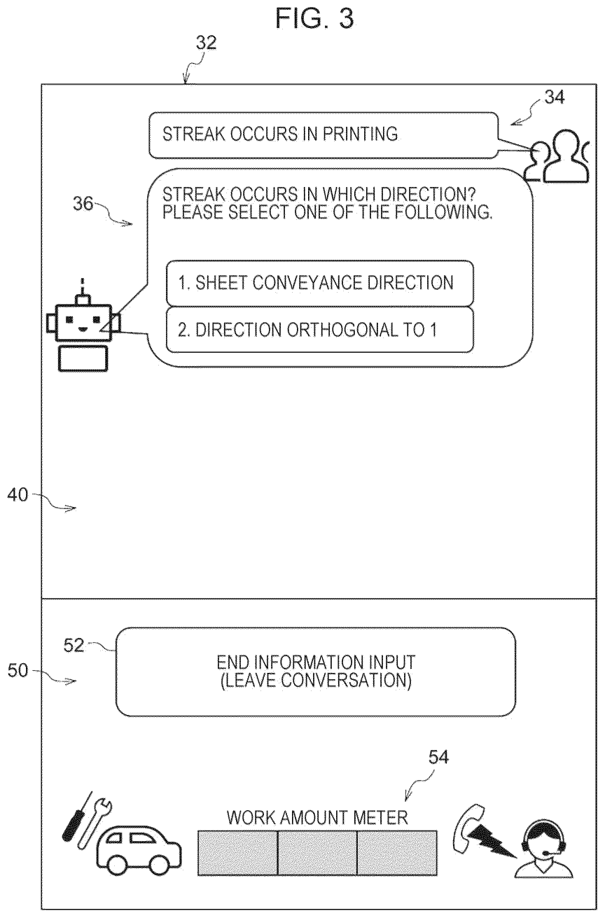

Next, an operation of the response system 10 according to the present exemplary embodiment will be described with reference to FIGS. 3 to 9.

### (Chat Display Area 40 and Status Display Area 50)

As illustrated in FIG. 3, an input screen 32 including a chat display area 40 and a status display area 50 is displayed on the display screen of the input device 30 for the user UR who uses the response system 10 according to the present exemplary embodiment.

As illustrated in FIG. 3, the chat display area 40 is an area in which the user UR inputs the status of the failure occurring in the printer 12. The user UR provides a chatbot CB, which is the response system 10, with information related to the failure having occurred in the printer 12 by inputting the details, status, and information of the failure occurring in the printer 12. In addition, in the chat display area 40, the question 36 with which the chatbot CB requires for further information related to the printer 12 is displayed based on input information 34 related to the failure having occurred in the printer 12, which has been input by the user UR. The user UR can provide information related to the failure having occurred in the printer 12 as additional input information 34 by answering the question 36 presented by the chatbot CB.

As illustrated in FIG. 3, the status display area 50 is an area in which an indication of the amount of work required from the user when a transition is made to another way of solution is displayed in accordance with the sufficiency level of the information provided from the user UR, and a work amount meter 54 that displays the amount of work required from the user is displayed. The work amount meter 54 is, for example, a so-called progress bar that displays, when the user UR inputs the input information 34, whether the amount of work required from the user is large or small when a transition is made to another way of solution in accordance with the sufficiency level of the information provided from the user UR included in the input information 34.

Further, in the status display area 50, as illustrated in FIG. 3, an end button 52 used by the user UR for inputting selection to end the conversation with the chatbot CB (to leave the conversation) is displayed.

In the following description, the “sufficiency level of information” indicates, for example, how precisely the cause of the failure having occurred in the printer 12, which is estimated based on the input information 34 that is the information provided from the user UR, is narrowed down. Specifically, a higher sufficiency level of information is assumed to indicate that the cause of the failure having occurred in the printer 12 is more precisely narrowed down, and a lower sufficiency level of information is assumed to indicate that the cause of the failure having occurred in the printer 12 is less precisely narrowed down. The amount of work required from the user when a transition is made to another way of solution in accordance with the sufficiency level of information is displayed as a current value 56 of the work amount meter 54.

Then, as illustrated in FIGS. 3 to 5, the user UR in the present exemplary embodiment provides information on the failure occurring in the printer 12 by appropriately inputting the input information 34 in response to the question presented from the chatbot CB displayed in the chat display area 40.

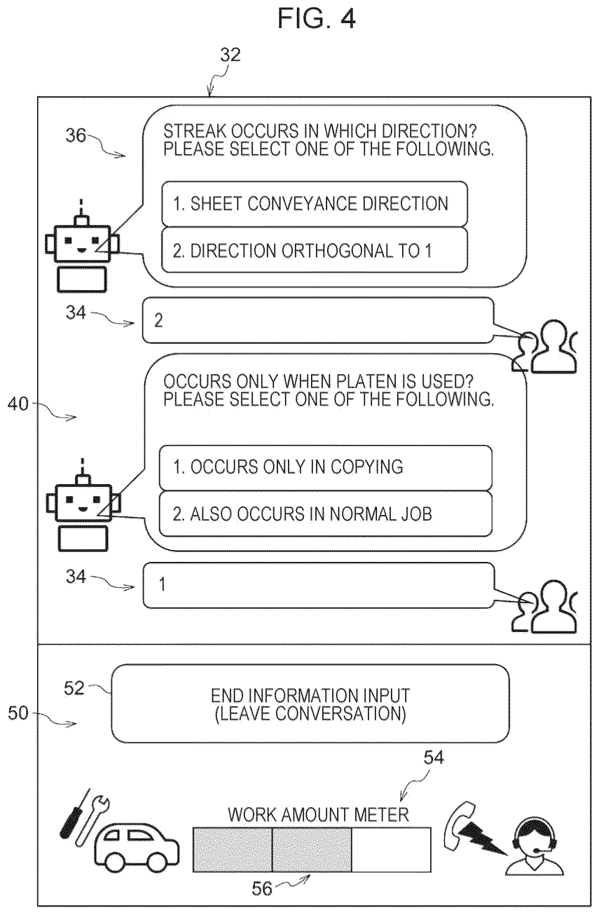

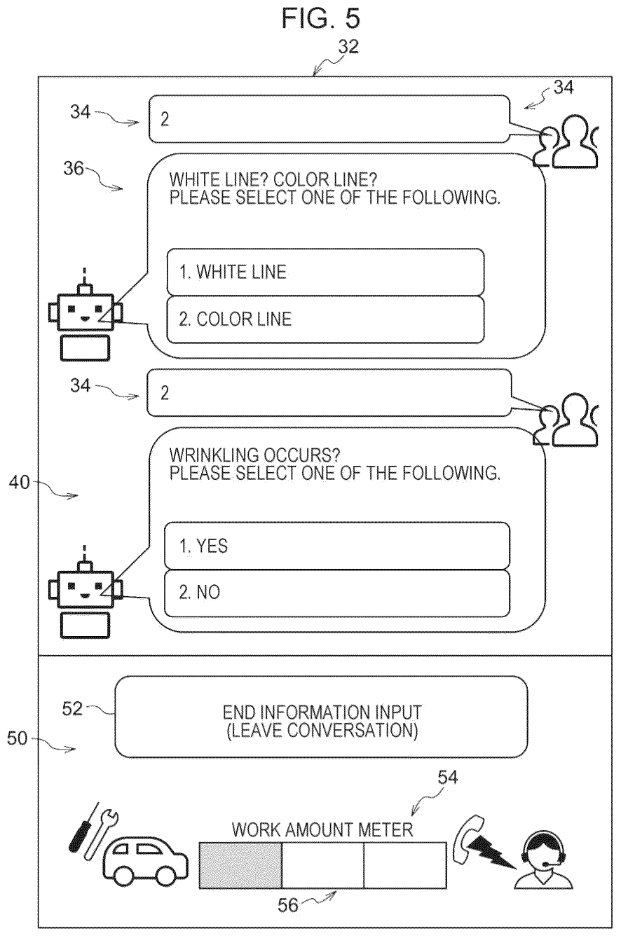

As illustrated in FIGS. 4 and 5, in the response system 10 according to the present exemplary embodiment, each time the user UR answers a question presented from the chatbot CB, a new question is presented from the chatbot CB displayed by the CPU 24A. As illustrated in FIGS. 4 and 5, the CPU 24A narrows down the cause of the failure occurring in the printer 12 based on the input information 34 provided from the user UR every time the user UR answers the question 36 presented from the chatbot CB.

Then, the CPU 24A changes the display of the work amount meter 54 based on how precisely the cause of the failure occurring in the printer 12, which is estimated based on the information provided from the user UR, is narrowed down. For example, in the example illustrated in FIGS. 3 to 5, in a procedure for receiving the details of the failure from the user UR, which will be described later, the current value 56 of the work amount meter 54 is displayed such that the smaller the number of possible failure cause candidates is, the higher the sufficiency level of information is. More specifically, in the example illustrated in FIGS. 3 to 5, the progress bar displayed indicating the current value 56 of the amount of work required from the user when a transition is made to another way of solution is shortened in response to an increase in the sufficiency level of the information.

In addition, in the response system 10 according to the present exemplary embodiment, the user UR can select the end button 52 at any timing. In other words, upon determining that he or she has finished answering the question 36 presented from the chatbot CB, the user UR can leave the conversation with the chatbot CB by intentionally selecting the end button 52. In the present exemplary embodiment, the user UR pressing the end button 52 to leave the conversation is an example of “attempt to interrupt provision of information” according to the present exemplary embodiment.

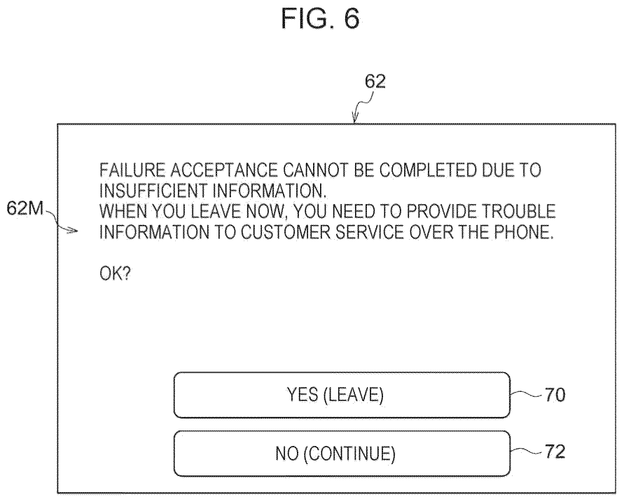

Here, in the response system 10 according to the present exemplary embodiment, when the end button 52 is selected, any one of confirmation indications in FIGS. 6 to 8 is displayed.

More specifically, in the response system 10 according to the present exemplary embodiment, when the CPU 24A determines that the sufficiency level of information is low at the timing when the end button 52 is selected, a first confirmation indication 62 illustrated in FIG. 6 is displayed. As illustrated in FIG. 6, a first work details notification 62M, a leave button 70, and a continue button 72 are displayed in the first confirmation indication 62.

In the first work details notification 62M illustrated in FIG. 6, it is described that the cause of the failure occurring in the printer 12 has failed to be narrowed down based on the information provided from the user UR, and that the repair person RR cannot be dispatched. Furthermore, it is described in the first work details notification 62M that the user UR needs to make a phone call to a responder or the like in a call center to explain the failure occurring in the printer 12. The user UR making the phone call to the call center is an example of the “work details of the user UR” according to the present exemplary embodiment.

In the present exemplary embodiment, in a case where the user UR selects the leave button 70 in a state where the first confirmation indication 62 is displayed, the response system 10 ends. Thereafter, the user UR will make a phone call to the call center, to explain the failure of the printer 12, for example. On the other hand, in a case where the user UR selects the continue button 72 in a state where the first confirmation indication 62 is displayed, the first confirmation indication 62 is erased, and the conversation with the chatbot CB is resumed as illustrated in FIGS. 3 to 5. The selection of the leave button 70 in a state where the first confirmation indication 62 is displayed to leave the conversation with the chatbot CB is an example of “a case where the provision of the information is interrupted and a transition is made to another way of solution” according to the present exemplary embodiment.

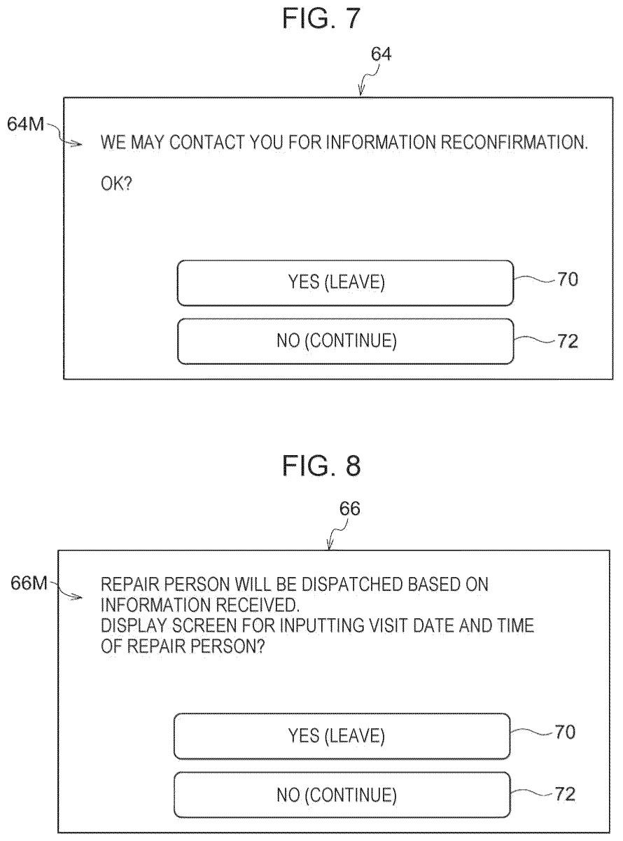

Furthermore, in the response system 10 according to the present exemplary embodiment, a second confirmation indication 64 illustrated in FIG. 7 is displayed when the CPU 24A determines that the sufficiency level of information is medium at the timing when the end button 52 is selected. As illustrated in FIG. 7, a second work details notification 64M, the leave button 70, and the continue button 72 are displayed in the second confirmation indication 64.

The second work details notification 64M illustrated in FIG. 7 indicates that the cause of the failure occurring in the printer 12 has not been satisfactorily narrowed down based on the information provided from the user UR, and that an inquiry for confirmation may be made to the user UR. In other words, it is described in the second work details notification 64M that the user UR may further respond to the inquiry. The user UR further responding to the inquiry is another example of the “work details of the user UR” according to the present exemplary embodiment.

In the present exemplary embodiment, in a case where the user UR selects the leave button 70 in a state where the second confirmation indication 64 is displayed, the response system 10 ends. However, the user UR may receive a phone call later on from the call center, for example, and explain the failure of the printer 12. On the other hand, in a case where the user UR selects the continue button 72 in a state where the second confirmation indication 64 is displayed, the second confirmation indication 64 is erased, and the conversation with the chatbot CB is resumed as illustrated in FIGS. 3 to 5.

Furthermore, in the response system 10 according to the present exemplary embodiment, a third confirmation indication 66 illustrated in FIG. 8 is displayed when the CPU 24A determines that the sufficiency level of information is high at the timing when the end button 52 is selected. As illustrated in FIG. 8, a third work details notification 66M, the leave button 70, and the continue button 72 are displayed in the third confirmation indication 66.

It is described in the third work details notification 66M illustrated in FIG. 8 that the cause of the failure occurring in the printer 12 has been satisfactorily narrowed down based on the information provided from the user UR, and therefore, the repair person RR is to be dispatched. In other words, it is described in the third work details notification 66M that the user UR does not need to further provide information on the failure occurring in the printer 12.

In the present exemplary embodiment, when the user UR selects the leave button 70 in a state where the third confirmation indication 66 is displayed, the response system 10 ends. Thereafter, a screen for inputting the date and time when the repair person is to be dispatched is displayed to the user UR as an example. On the other hand, when the user UR selects the continue button 72 in a state where the third confirmation indication 66 is displayed, the third confirmation indication 66 is erased, and the conversation with the chatbot CB is resumed as illustrated in FIGS. 3 to 5.

Next, a procedure for receiving the details of the failure from the user UR, which is executed by the CPU 24A of the response system 10 according to the present exemplary embodiment, will be described.

### (Procedure for Receiving Details of Failure From User UR)

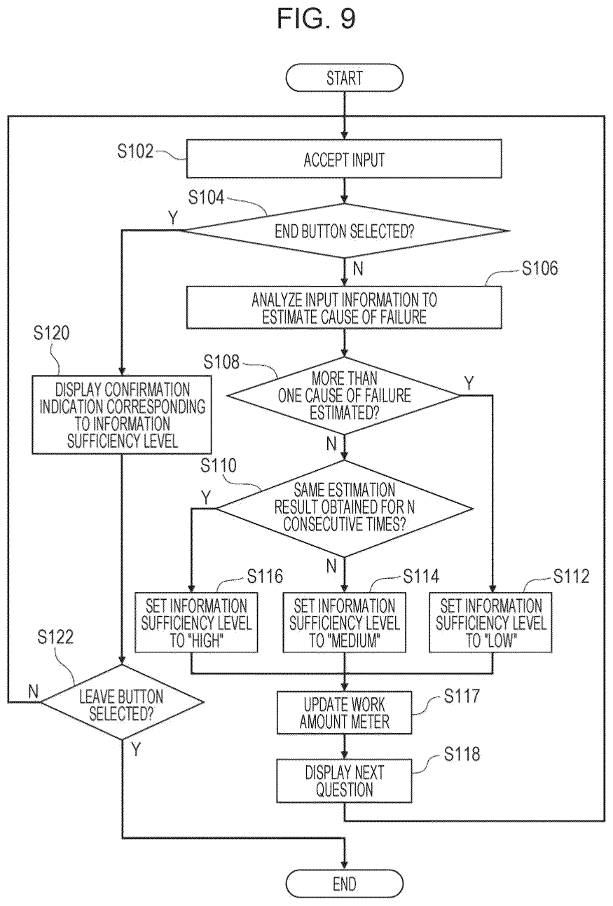

The program 25 of the response system 10 executed by the CPU 24A includes a procedure illustrated in FIG. 9. Although not elaborated in FIG. 9, the CPU 24A assumes, as the initial value, the sufficiency level of information to be “low” at the time when the procedure of receiving the details of the failure from the user UR is started.

First of all, in step S102, the CPU 24A receives an input from the user UR. More specifically, in step S102, the CPU 24A waits until the end button 52 is selected or new information is provided. Next, when the end button 52 is selected or new information is provided, the CPU 24A proceeds to step S104.

Next, in step S104, the CPU 24A determines whether the end button 52 has been selected. Upon determining NO in step S104, in other words, when new information is provided from the user UR, the CPU 24A proceeds to step S106. On the other hand, upon determining YES in step S104, in other words, when the user UR selects the end button 52, the CPU 24A proceeds to step S120.

Next, in step S106, the CPU 24A analyzes the information provided from the user UR and estimates the cause of the failure occurring in the printer 12. More specifically, the CPU 24A estimates the cause of the failure occurring in the printer 12 based on the information provided from the user UR and input to the chat display area 40. Then, the CPU 24A proceeds to step S108.

Next, the CPU 24A determines the number of estimated causes of the failure in step S108. More specifically, in step S108, the CPU 24A determines whether more than one (two or more) cause of the failure has been estimated in step S106. The case where more than one cause of the failure has been estimated is an example of a “case where the sufficiency level of information does not satisfy a predetermined threshold” according to the present exemplary embodiment. Upon determining NO in step S108, the CPU 24A proceeds to step S110. On the other hand, upon determining YES in step S108, the CPU 24A proceeds to step S112.

Next, in step S110, the CPU 24A determines how many times the same result has been obtained in succession for the cause of the failure occurring in the printer 12 estimated in step S106. More specifically, the CPU 24A determines whether all the estimation results are the same in the latest predetermined number of times of the number of times step S106 has been executed. Note that a case where all the estimation results are the same in the latest predetermined number of times is an example of a “case where a sufficiency level of the information exceeds a predetermined threshold” according to the present exemplary embodiment. Upon determining YES in step S110, the CPU 24A proceeds to step S116. On the other hand, upon determining NO in step S110, in other words, when different estimation results are obtained, or when step S106 has not been executed for a predetermined number of times yet, the CPU 24A proceeds to step S114.

Next, upon proceeding to step S112, the CPU 24A determines that the sufficiency level of information is “low”. Then, the CPU 24A proceeds to step S117.

Upon proceeding to step S114, the CPU 24A determines that the sufficiency level of information is “medium”. Then, the CPU 24A proceeds to step S117.

Upon proceeding to step S116, the CPU 24A determines that the sufficiency level of information is “high”. Then, the CPU 24A proceeds to step S117.

Next, in step S117, the CPU 24A updates the display of the current value 56 of the work amount meter 54 in accordance with the sufficiency level of information updated in step S112, step S114, or step S116. More specifically, upon determining the sufficiency level of information to be “low”, the CPU 24A displays the work amount meter 54 the entirety of which is filled as illustrated in FIG. 3. Upon determining the sufficiency level of information to be “medium”, the CPU 24A displays the work amount meter 54 about two thirds of which is filled as illustrated in FIG. 4. Upon determining the sufficiency level of information to be “high”, the CPU 24A displays the work amount meter 54 about one third of which is filled as illustrated in FIG. 5 for example. Then, the CPU 24A proceeds to step S118.

Next, in step S118, the CPU 24A displays the next question 36 in the chat display area 40. More specifically, in step S118, the CPU 24A displays the new question 36 in the chat display area 40, and prompts the user UR to provide new information. Then, the CPU 24A proceeds to step S102.

Upon proceeding to step S120, the CPU 24A displays a confirmation indication corresponding to the sufficiency level of information on the input screen 32. More specifically, when the user UR selects the end button 52 in a state where the sufficiency level of information is determined to be “low”, the CPU 24A displays the first confirmation indication 62 illustrated in FIG. 6 as the confirmation indication for the sufficiency level of information “low”. When the user UR selects the end button 52 in a state where the sufficiency level of information is determined to be “medium”, the CPU 24A displays the second confirmation indication 64 illustrated in FIG. 7 as the confirmation indication for the sufficiency level of information “medium”. When the user UR selects the end button 52 in a state where the sufficiency level of information is determined to be “high”, the CPU 24A displays the third confirmation indication 66 illustrated in FIG. 8 as the confirmation indication for the sufficiency level of information “high”. Then, the CPU 24A proceeds to step S122.

Next, in step S122, the CPU 24A determines whether the leave button 70 is selected. More specifically, the CPU 24A determines in step S122 whether the leave button 70 in the first confirmation indication 62, the second confirmation indication 64, or the third confirmation indication 66 has been selected. Then, upon determining NO in step S122, the CPU 24A erases the first confirmation indication 62, the second confirmation indication 64, or the third confirmation indication 66, and then proceeds to step S102. On the other hand, upon determining YES in step S122, the CPU 24A ends the procedure for receiving the details of the failure from the user UR.

Note that in the present exemplary embodiment, the CPU 24A displays a telephone number to the call center on the display screen of the input device 30 for the user UR when ending the procedure for receiving the details of the failure from the user UR, with the sufficiency level of information being “low”. The CPU 24A provides the information obtained based on the information provided from the user UR to the repair person RR, when the procedure for receiving the details of the failure from the user UR ends with the sufficiency level of information being “medium” or “high”.

A larger amount of information on the failure having occurred in the printer 12 provided from the user UR leads to a lower risk for the repair person RR encountering an unexpected situation. In other words, the information on the failure provided from the user UR to the repair person RR may be provided until it is determined YES in step S110 described above.

Therefore, in the response system 10 according to the present exemplary embodiment, the CPU 24A further displays the question 36 to the user UR even after proceeding to step S116 illustrated in FIG. 9, meaning that the sufficiency level of information is “high”. In other words, the CPU 24A repeats steps S102 to S118 illustrated in FIG. 9 to further continue prompting the user UR to provide information, thereby causing calculation of the sufficiency level of information.

With the response system 10 and the program 25 according to the present exemplary embodiment, the following operations and effects are achieved.

### (Operations and Effects)

The response system 10 according to the present exemplary embodiment requests the user UR who uses the printer 12 in which a failure has occurred to provide information on the failure of the printer 12, and displays the status display area 50. Therefore, with the response system 10 according to the present exemplary embodiment, in the response system 10 that collects information provided from the user UR who uses the printer 12 in which the failure has occurred, it is possible to prompt the user UR to continue providing information.

The response system 10 according to the present exemplary embodiment displays the work amount meter 54 indicating whether the amount of work required when the user UR selects the leave button 70 is large or small. Therefore, with the response system 10 according to the present exemplary embodiment, the provision of information from the user UR is more likely to be continued than in a case where the work details required by the user UR are directly displayed using only the status display area 50.

The response system 10 according to the present exemplary embodiment displays, as the first confirmation indication 62, the second confirmation indication 64, or the third confirmation indication 66, the work details of the user UR required when the user UR selects the leave button 70 in a state where the user UR has selected the end button 52. Thus, with the response system 10 according to the present exemplary embodiment, the voluntary provision of information by the user UR is less likely to be interrupted than in a case where only the status display area 50 is always displayed, and thus the user UR is likely to concentrate on the provision of information.

The response system 10 according to the present exemplary embodiment continues requesting the provision of information until the user UR attempts to select the end button 52. Therefore, with the response system 10 according to the present exemplary embodiment, the voluntary provision of information by the user UR is less likely to be interrupted than in a case where the amount of information received from the user UR is limited, and thus a larger amount of information is likely to be provided from the user UR.

The response system 10 according to the present exemplary embodiment further displays the work amount meter 54 indicating the information sufficiency level even when the sufficiency level of the information provided from the user UR exceeds the threshold. Therefore, with the response system 10 according to the present exemplary embodiment, compared with a case where the display of the current value 56 of the work amount meter 54 is stopped when the information on the failure of the printer 12 is sufficiently accumulated, it is possible to prompt the user UR to continue the provision of information.

The program 25 according to the present exemplary embodiment causes a processor to execute requesting the user UR who uses the printer 12 in which the failure has occurred to provide information on the failure of the printer 12, and displaying the first confirmation indication 62 when the information sufficiency level included in the information provided from the user UR is lower than the predetermined threshold. Therefore, with the program 25 according to the present exemplary embodiment, in a program for collecting information provided from the user UR who uses the printer 12 in which the failure has occurred, it is possible to prompt the user UR to continue providing information.

### (Modifications)

In the above description, the CPU 24A provides the user UR with the sufficiency level of information by displaying the work amount meter 54. However, the response system 10 according to the present exemplary embodiment is not limited thereto as long as it is possible to provide the user UR with the current value 56 of the sufficiency level of information. For example, instead of the method of displaying the progress bar as the work amount meter 54, the information sufficiency level may be displayed by a numerical value, or may be indicated by the size, shape, position, color, or the like of an icon or the like displayed in the status display area 50. Further, instead of the display using the status display area 50, the information sufficiency level may be provided to the user UR as auditory information such as sound emitted.

Furthermore, in the above description, the CPU 24A includes, in the first confirmation indication 62, the description indicating that the user UR makes a phone call to the call center, but the response system 10 according to the present exemplary embodiment is not limited thereto. For example, as the first work confirmation indication, only a message indicating that the repair person RR cannot be dispatched may be displayed, and the description indicating that the user UR also needs to make a phone call to the call center may be omitted.

Furthermore, in the above description, the CPU 24A displays the first work details notification 62M when the user UR selects the end button 52, but the response system 10 according to the present exemplary embodiment is not limited thereto. For example, a mode may be adopted in which the CPU 24A constantly displays the first work details notification 62M in the status display area 50.

In the above description, the CPU 24A keeps asking the user UR questions until the user UR selects the end button 52. However, the response system 10 according to the present exemplary embodiment is not limited thereto. For example, when the sufficiency level of information is determined to be “high”, the CPU 24A may stop asking the user UR additional questions.

Furthermore, while the CPU 24A continues displaying the work amount meter 54 even after determining that the sufficiency level of information is “high” in the description above, the response system 10 according to the present exemplary embodiment is not limited thereto. For example, when the CPU 24A determines that the sufficiency level of information is “high”, the work amount meter 54 displayed may be erased.

Even with these modifications, it is possible to obtain the same operations and effects as those described above.

While the exemplary embodiments of the present disclosure have been described with reference to the accompanying drawings, it is apparent that those skilled in the art to which the present disclosure pertains can conceive various modifications and applications within the scope of the technical idea described in the claims, and it is to be understood that these naturally belong to the technical scope of the present disclosure.

### Appendix

(((1)))

An information processing system comprising a processor configured to, when a solution request for a failure of a device in which the failure has occurred is received from a user who uses the device, request the user to provide information related to solution for the failure, and display, to the user, an indication related to an amount of work required from the user when a transition is made to another way of solution for the failure.

(((2)))

The information processing system according to (((1))), wherein the indication includes whether an amount of work required when the user interrupts provision of information is large or small.

(((3)))

The information processing system according to (((1))) or (((2))), wherein in a case where the user attempts to interrupt provision of information, the processor is configured to display an amount of work for the user when a transition is made to another way of solution.

(((4)))

The information processing system according to any one of (((1)) to (((3))), wherein the processor is configured to continue requesting for provision of information until the user attempts to interrupt provision of information.

(((5)))

The information processing system according to (((4))), wherein the processor is configured to display the indication also in a case where a sufficiency level of the information on the failure based on provision of the information from the user exceeds a predetermined threshold.

(((6)))

A program causing a processor to execute a process comprising:
requesting, when a solution request for a failure of a device in which the failure has occurred is received from a user who uses the device, the user to provide information related to solution for the failure; and
displaying, to the user, an indication related to an amount of work required from the user when a transition is made to another way of solution for the failure.

What is claimed is:

1. An information processing system comprising:
a processor configured to, when a solution request for a failure of a device in which the failure has occurred is received from a user who uses the device, request the user to provide information related to solution for the failure, and display, to the user, an indication related to an amount of work required from the user when a transition is made to another way of solution for the failure.

2. The information processing system according to claim 1, wherein the indication includes whether an amount of work required when the user interrupts provision of information is large or small.

3. The information processing system according to claim 1, wherein in a case where the user attempts to interrupt provision of information, the processor is configured to display work details for the user when a transition is made to another way of solution.

4. The information processing system according to claim 1, wherein the processor is configured to continue requesting for provision of information until the user attempts to interrupt provision of information.

5. The information processing system according to claim 2, wherein the processor is configured to continue requesting for provision of information until the user attempts to interrupt provision of information.

6. The information processing system according to claim 3, wherein the processor is configured to continue requesting for provision of information until the user attempts to interrupt provision of information.

7. The information processing system according to claim 4, wherein the processor is configured to display the indication also in a case where a sufficiency level of the information on the failure based on provision of the information from the user exceeds a predetermined threshold.

8. The information processing system according to claim 5, wherein the processor is configured to display the indication also in a case where a sufficiency level of the information on the failure based on provision of the information from the user exceeds a predetermined threshold.

9. The information processing system according to claim 6, wherein the processor is configured to display the indication also in a case where a sufficiency level of the information on the failure based on provision of the information from the user exceeds a predetermined threshold.

10. A non-transitory computer readable medium storing a program causing a processor to execute a process comprising:
requesting, when a solution request for a failure of a device in which the failure has occurred is received from a user who uses the device, the user to provide information related to solution for the failure; and
displaying, to the user, an indication related to work details required by the user when a transition is made to another way of solution for the failure.
